(19) United States
(12) Patent Application Publication
(10) Pub. No.: US 2014/0081040 A1
(43) Pub. Date: Mar. 20, 2014

(54) PROCESS FOR PRE-TREATMENT OF A CATALYST SUPPORT AND CATALYST PREPARED THEREFROM

(71) Applicants: Daniel T. Shay, Houston, TX (US); Sallie J. Lee, Havertown, PA (US)

(72) Inventors: Daniel T. Shay, Houston, TX (US); Sallie J. Lee, Havertown, PA (US)

(73) Assignee: LYONDELL CHEMICAL TECHNOLOGY, L.P., Houston, TX (US)

(21) Appl. No.: 13/623,213

(22) Filed: Sep. 20, 2012

(51) Int. Cl. B01J 23/68; B01J 23/52

(52) U.S. Cl. CPC B01J 23/687; B01J 23/52
USPC 560/243; 502/330; 502/309

(57) ABSTRACT

Methods of forming noble metal catalysts, noble metal catalysts formed therefrom and process for using noble metal catalysts are described herein. The methods generally include contacting a support material with a pre-treatment agent including a dilute basic solution of an alkali or alkaline earth metal to form a contacted support; drying the contacted support to form a pre-treated support; and impregnating the pre-treated support with at least one noble metal to form the noble metal catalyst.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

1. Field

The present invention generally relates to methods of forming noble metal catalysts and the catalysts formed therefrom. More particularly, the present invention relates to methods of pre-treating noble metal catalysts.

2. Related Art

This section introduces information from the art that may be related to or provide context for some aspects of the technique described herein and/or claimed below. This information is background facilitating a better understanding of that which is disclosed herein. This is a discussion of “related” art. That such art is related in no way implies that it is also “prior” art. The related art may or may not be prior art. The discussion is to be read in this light, and not as admissions of prior art.

Noble metal catalysts, and in particular palladium-gold catalysts, are useful in a variety of processes, such as the oxidation of ethylene or propylene in the presence of acetic acid to produce vinyl acetate or allyl acetate (acetoxylation processes). The noble metal catalysts may be supported on TiO₂/WO₃ or on TiO₂, for example. Reducing metal loss from catalyst processing is desirable to increase catalyst activity. Furthermore, palladium and gold are expensive precious metals. Therefore, many efforts have been made to increase the catalyst activity while reducing the amount of metal needed.

The present invention is directed to resolving, or at least reducing, one or all of the problems mentioned above.

### SUMMARY

Various embodiments of the present invention include methods of forming noble metal catalysts. The methods generally include contacting a support material with a pre-treatment agent including a dilute basic solution of an alkali or alkaline earth metal (i.e., Group I or II of the Periodic Table) to form a contacted support; drying the contacted support to form a pre-treated support; and impregnating the pre-treated support with at least one noble metal to form the noble metal catalyst exhibiting a catalyst activity greater than a comparative activity of a catalyst formed from a same process absent the contact with the pre-treatment agent.

One or more embodiments include the method of the preceding paragraph, wherein the support material is selected from titania, tungsten trioxide and combinations thereof.

One or more embodiments include the method of any preceding paragraph, wherein the dilute basic solution is selected from hydroxides, carbonates and combinations thereof.

One or more embodiments include the method of any preceding paragraph, wherein the dilute basic solution is saturated.

One or more embodiments include the method of any preceding paragraph, wherein the pre-treatment agent includes NaHCO₃.

One or more embodiments include the method of any preceding paragraph, wherein the pre-treatment agent contacts the catalyst support in an amount of from 0.1 times the volume of the support material to a volume sufficient to saturate the support material.

One or more embodiments include the method of any preceding paragraph, wherein the pre-treatment agent contacts the catalyst support for a time of at least 10 minutes.

One or more embodiments include the method of any preceding paragraph, wherein the noble metal is selected from palladium, gold and combinations thereof.

One or more embodiments include the method of any preceding paragraph, wherein the noble metal includes palladium and gold.

One or more embodiments include the method of any preceding paragraph, wherein the catalyst comprises from 0.75 wt. % to 1 wt. % palladium and from 0.35 wt. % to 0.6 wt % gold based on the total weight of the catalyst.

One or more embodiments include the method of any preceding paragraph, wherein the noble metal catalyst activity is at least 15% greater than the comparative activity.

One or more embodiments include the method of any preceding paragraph, wherein the support material is calcined prior to contact with the pre-treatment agent.

One or more embodiments include the method of any preceding paragraph, wherein the support material is calcined at a calcining temperature of from 450° C. to 1100° C. prior to contact with the pre-treatment agent.

One or more embodiments include the method of any preceding paragraph further including contacting the at least one noble metal with a fixing agent prior to impregnating the support material with the at least one noble metal.

One or more embodiments include the method of any preceding paragraph, wherein the fixing agent is selected from alkali or alkaline earth metals, ammonium compounds and combinations thereof.

One or more embodiments include a noble metal catalyst formed by the method of any preceding paragraph.

One or more embodiments include the method of any preceding paragraph, wherein the support material is titania.

One or more embodiments include the method of any preceding paragraph, wherein the support material is submerged in the pre-treatment agent to form the contacted support.

One or more embodiments include the noble metal catalyst of any preceding paragraph, wherein the noble metal catalyst has a shell thickness of less than 250 μm.

One or more embodiments include the method of any preceding paragraph, wherein the support material includes titania and tungsten trioxide.

A noble metal catalyst of any preceding paragraph, wherein the noble metal catalyst exhibits a metal retention rate of at least 90%.

One or more embodiments include an acetoxylation process. The acetoxylation process generally includes contacting an olefin with acetic acid in the presence of the noble metal catalyst of any preceding paragraph to form an acetoxylated olefin; and recovering the acetoxylated olefin.

One or more embodiments include the process of any preceding paragraph, wherein the olefin includes ethylene and the acetoxylated olefin includes vinyl acetate.

One or more embodiments include the process of any preceding paragraph, wherein the process exhibits a productivity of at least 250 g acetoxylated olefin/Lcat-h and an ethylene selectivity of at least 94% while maintaining at least 20% oxygen conversion.

One or more embodiments include an acetoxylation process. The acetoxylation process generally includes contacting an olefin with acetic acid in the presence of an acetyloxylation catalyst to form an acetoxylated olefin including vinyl acetate; and recovering the acetoxylated olefin; wherein the noble metal catalyst is formed by a process including providing a support material including a refractory metal oxide selected from titania, tungsten trioxide and combinations thereof; calcining the support material to form a calcined support; contacting the calcined support with a pre-treatment agent including a dilute basic solution of an alkali or alkaline earth metal to form a contacted support; drying the contacted support to form a pre-treated support; impregnating the pre-treated support with noble metals including gold and palladium to form a catalyst, wherein the noble metals are impregnated in the presence of a fixing agent selected from alkali or alkaline earth metals, ammonium compounds and combinations thereof; and washing the catalyst to form the noble metal catalyst, wherein the noble metal catalyst exhibits a catalyst activity that is greater than a comparative activity of a catalyst formed from an identical process absent the contact with the pre-treatment agent.

The above paragraphs present a simplified summary of the presently disclosed subject matter in order to provide a basic understanding of some aspects thereof. The summary is not an exhaustive overview, nor is it intended to identify key or critical elements to delineate the scope of the subject matter claimed below. Its sole purpose is to present some concepts in a simplified form as a prelude to the more detailed description set forth below.

### BRIEF DESCRIPTION OF DRAWINGS

The claimed subject matter may be understood by reference to the following description taken in conjunction with the accompanying drawings, in which like reference numerals identify like elements, and in which:

FIG. 1 is a picture that shows a comparison of the first three washings of an untreated and treated sample.

FIG. 2 is a qualitative depiction of the phenomena of the thinner shell catalyst with pretreatment.

FIG. 3 is a cross section of catalyst showing that the shell thickness of active metal for the pretreated support is thinner than the untreated support.

FIG. 4 is a cross section of the untreated supported catalyst depicting the metal penetration depth.

FIG. 5 is a cross section of the treated supported catalyst depicting the metal penetration depth.

While the invention is susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Illustrative embodiments of the subject matter claimed below will now be disclosed. In the interest of clarity, not all features of an actual implementation are described in this specification. It will be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

In the description below, unless otherwise specified, all compounds described herein may be substituted or unsubstituted and the listing of compounds includes derivatives thereof. Further, various ranges and/or numerical limitations may be expressly stated below. It should be recognized that unless stated otherwise, it is intended that endpoints are to be interchangeable. Further, any ranges include iterative ranges of like magnitude falling within the expressly stated ranges or limitations.

Embodiments described herein include methods of forming noble metal catalysts. The methods generally include contacting a support material with a pre-treatment agent prior to contact with a metal component, thereby resulting in a catalyst having greater activity than a comparative activity of a catalyst formed from an identical process absent the contact with the pre-treatment agent. As used herein, the term “catalyst activity” refers to weight of product produced per weight of the catalyst used in a process at a standard set of conditions per unit time and is used interchangeably with the term productivity herein.

Noble metal catalysts are generally formed from the combination of a metal component (e.g., a potentially active catalyst site) with one or more additional components, such as a support material, for example. In the embodiments described herein, the noble metal catalyst generally includes a support material and at least one noble metal. The support material may be formed by known methods. For example, methods of forming support materials can include those described in WO 2011/075278, which is incorporated by reference herein.

In one or more embodiments, the support material includes a refractory support material. The refractory support material may include at least one refractory metal oxide. As used herein, “refractory metals” include titanium, vanadium, chromium, zirconium, niobium, molybdenum, ruthenium, rhodium, hafnium, tantalum, tungsten, rhenium, osmium and iridium. In one or more embodiments, the at least one refractory metal oxide is selected from silica, silica-alumina, titania, zirconia, tungsten trioxide and combinations thereof, for example. In one or more specific embodiments, the support material is selected from titania, tungsten trioxide and combinations thereof.

The support material may have a specific surface area of from 0.5 m²/g to 500 m²/g, or from 1 m²/g to 200 m²/g, or from 2 m²/g to 50 m²/g, or from 10 m²/g to 50 m²/g, for example. The support material may have a pore volume of from 0.1 cc/g to 3.5 cc/g or from 0.2 cc/g to 2.5 cc/g or from 0.5 cc/g to 0.75 cc/g, for example.

In one or more specific embodiments, the support material includes titania. In one or more embodiments, the support material includes greater than 50 wt. % titania. For example, the support material may include at least 50 wt. % titania, or at least 60 wt. % titania, or at least 70 wt. % titania, or at least 80 wt. % titania, or at least 90 wt. % titania, for example. When utilizing such a support material, the resulting noble metal catalysts are generally shell type catalysts (or layer type catalysts) in which the active metals are distributed in a thin outer rim or layer of material.

In one or more specific embodiments, the support material is titania (i.e., the support material contains a single refractory metal oxide). In another embodiment, the support material may include titania and tungsten trioxide, for example. When the support material includes both titania and tungsten trioxide, the support material may include titania in the amounts described previously herein and from 0.1 wt. % to 49 wt. %, or from 0.1 wt. % to 15 wt. %, or from 0.5 wt. % to 8 wt. % or from 0.75 wt. % to 5 wt. % or from 5 wt. % to 15 wt. % tungsten, for example.

The at least one noble metal may include any noble metal or combination of noble metals. In one or more specific embodiments, the at least one noble metal is selected from gold, palladium and combinations thereof. In one or more specific embodiments, the noble metal catalyst includes more than one noble metal. For example, the noble metal catalyst may include gold and palladium. When both gold and palladium are present in the noble metal catalyst, the catalyst may include from 0.1 wt. % to 3 wt. %, or from 0.75 wt. % to 1 wt. %, or from 0.25 wt. % to 0.75 wt. % gold and from 0.1 wt. % to 3 wt. %, or from 0.35 wt. % to 0.6 wt. %, or from 0.5 wt. % to 1.5 wt. % palladium, for example (wt. % based on the total weight of noble metal catalyst). Further, in such an embodiment, the noble metal catalyst may have a weight ratio of palladium to gold of from 5:1 to 0.3:1, or from 3:1 to 0.5:1, or from 1.5:1 to 0.75:1, or from 1.25:1 to 0.9:1, for example.

The support material is impregnated with the at least one noble metal to form the noble metal catalyst. The impregnation may include methods known in the art. See, U.S. Letters Pat. No. 6,022,823, which is incorporated by reference herein. In one or more embodiments, the impregnation includes contacting the support material with the at least one noble metal in the form of noble metal salt. For example, the support material may be contacted with an aqueous solution of the noble metal salt. The concentration of the solution(s) and the amount of solution(s) used may be governed by the concentration of noble metal desired in the final catalyst product. When utilizing more than one noble metal, the impregnation may include simultaneous or successive impregnation with the noble metals.

Examples of palladium salts include, but are not limited to, palladium chloride, sodium chloropalladate, palladium nitrate, palladium sulfate and combinations thereof, for example. Examples of gold salts include, but are not limited to, auric chloride, tetrachloroauric acid, sodium tetrachloroaurate and combinations thereof, for example.

One or more embodiments include impregnating the support material with the at least one noble metal in the presence of a fixing agent. The fixing agent is adapted to bind the at least one noble metal to the support material. Such contact may occur via a variety of methods. One method includes contacting the at least one noble metal with the fixing agent prior to impregnation and dropping or spraying the mixture onto the support material. For example, the at least one noble metal and the fixing agent may be dropped or sprayed onto the support material until incipient wetness is achieved. Alternatively, the support material may be slurried in the mixture of the at least one noble metal and the fixing agent, for example.

The fixing agent may be selected from alkali or alkaline earth metals or ammonium compounds, for example. The alkali or alkaline earth metal or ammonium compound may include alkali or alkaline earth metal or ammonium hydroxides, alkali or alkaline earth metal or ammonium carbonates, alkali or alkaline earth metal or ammonium bicarbonates, alkali or alkaline earth metal or ammonium metasilicates and combinations thereof, for example. In one or more specific embodiments, the fixing agent includes sodium bicarbonate.

Upon impregnation, the noble metal catalyst may be washed with an aqueous liquid, such as water or other solvents, to remove any undesirable compounds (e.g., halide) remaining thereon. The wash may include a single wash or a series of washes, for example.

Optionally, the noble metal catalyst may be dried. The drying may occur at a drying temperature of from 50° C. to 150° C. at atmospheric pressure or under vacuum, primarily to remove at least a portion of solvent. The drying may occur in air or an inert atmosphere, for example.

Unfortunately, one or more of the steps utilized to form the noble metal catalysts, such as washing, can result in a lower level of metal deposition than desired or an undesirable shell thickness/distribution within the noble metal catalyst. However, one or more embodiments include contacting the support material with a pre-treatment agent to form a contacted support. The contact with the pre-treatment agent occurs prior to impregnation of the at least one noble metal. The pre-treatment agent is a dilute basic solution of an alkali or alkaline earth metal. In one or more embodiments, the dilute basic solution is saturated. As used herein, the term “saturated” refers to the point at which a solution of a substance can dissolve no more of that substance and additional amounts of it will appear as a separate phase. The dilute basic solution may have a molar concentration of from 0.001M to 50M, or from 0.1M to 10M, or from 0.5M to 5M at 25° C., for example.

In one or more embodiments, the dilute basic solution is selected from hydroxides, carbonates and combinations thereof. In one or more specific embodiments, the pre-treatment agent includes sodium bicarbonate (NaHCO₃).

The support material may contact the pre-treatment agent via a variety of methods. For example, the support material may be submerged in the pre-treatment agent. Alternatively, the pre-treatment agent may be dripped or sprayed over the support material.

In one or more embodiments, the pre-treatment agent contacts the support material in an amount of from 0.1, or from 0.5, or from 0.85 times the volume of the support material to a volume sufficient to saturate the support material. The time of contact will vary and may be of a time sufficient to improve metal adhesion; however, the time may be at least 10 minutes, or from 10 minutes to 30 minutes, for example.

After contacting the support material with the pre-treatment agent to form the contacted support, the contacted support may be dried to form a pre-treated support.

The methods of forming the noble metal catalyst described herein may include one or more calcining steps. The calcining may include contacting the support material, the noble metal catalyst or combinations thereof with a gas to burn off residual volatile compounds. Suitable gases may include inert or oxidizing gases, such as helium, nitrogen, argon, neon, oxygen, air, carbon dioxide and combinations thereof, for example. Calcining may occur at a calcining temperature of from 450° C. to 1100° C., or from 600° C. to 900° C., or from 650° C. to 800° C., for example. The time of calcining will vary by process, but may occur for a time of from 1 to 5 hours, for example

In one or more embodiments, the support material is calcined prior to contact with the pre-treatment agent.

In one or more embodiments, the noble metal catalyst (either prior to or after optional calcining) may be chemically reduced to form a reduced catalyst. The reduction may be performed by contacting the noble metal catalyst with a reducing agent. The reducing agent may be selected from hydrogen, carbon monoxide, hydrocarbons, olefins, aldehydes, alcohols, hydrazine, ammonia, primary amines, carboxylic acids, carboxylic acid salts, carboxylic acid esters and combinations thereof, for example. The reduction may occur at ambient temperature up to 550° C., or from 100° C. to 550° C., for example.

Those skilled in the art will recognize that a catalyst may be “activated” in some way. Activation may be accomplished by contacting the catalyst with an activator, which is also referred to in some instances as a “co-catalyst”. The activators may or may not be associated with or bound to the support material, either in association with the catalyst or separate from the catalyst component. The activator may include an alkali or alkaline earth metal compound, such as hydroxides, acetates, nitrates, carbonates and bicarbonates of potassium, sodium, cesium, magnesium, barium or combinations thereof, for example. In one or more embodiments, the activator includes a potassium salt. In one or more embodiments, the noble metal catalyst may include from 0 wt. % to 15 wt. %, or from 1.5 wt. % to 10 wt. % activator.

Once the noble metal catalyst is prepared, a variety of processes may be carried out using that composition. Such processes may include, but are not limited to partial oxidation, hydrogenation, carbonylation, ammonia synthesis, selective hydrogenation, acetoxylation, catalytic combustion or complete oxidation, three way catalysis, NOx removal, methanol synthesis, hydrogen peroxide synthesis, hydroformylation, alkylation and alkyl transfer, oxidative carbonylation, coupling of olefins with aromatics and preparation of methyl isobutyl ketone from acetone, for example.

Specific processes utilizing the noble metal catalyst include acetoxylation processes. In these contexts, the noble metal catalyst may be referred to as an acetoxylation catalyst. Acetoxylation processes generally include processes whereby olefins are converted to acetoxylated olefins by oxidation in the presence of acetic acid and a noble metal catalyst.

In one or more specific embodiments, the noble metal catalyst is utilized in an acetoxylation process including the oxidation of an olefin, such as ethylene or propylene, in the presence of acetic acid and a noble metal catalyst to produce an acetoxylated olefin, such as vinyl acetate or allyl acetate (e.g., acetoxylation). One specific acetoxylation process includes converting ethylene to vinyl acetate.

Acetoxylation processes may include those known in the art including vapor phase or fluidized bed processes, for example. The equipment, process conditions, reactants, additives and other materials used in such processes will vary in a given process, depending on the desired composition and properties of the desired product. Various processes for producing acetoxylated olefins, such as vinyl acetate and allyl acetate are known. See, U.S. Letters Pat. No. 3,743,607 and U.S. Pat. No. 3,775,342, which are incorporated by reference herein. For example, vapor phase acetoxylation processes may include reaction temperatures of from 100° C. to 250° C. or from 125° C. to 200° C. and pressures of from 15 psig to 500 psig. Vapor phase acetoxylation processes for the formation of vinyl acetate may include feeding from 20 mol. % to 70 mol % ethylene, from 2 mol. % to 8 mol. % oxygen and from 2 mol. % to 20 mol. % acetic acid to the reaction zone, for example.

Acetoxylated olefins may be utilized in a variety of applications. For example, vinyl acetate may be utilized to form polyvinyl acetate. Polyvinyl acetate is a component of a widely-used type of glue, referred to variously as wood glue, white glue, carpenter's glue, school glue or PVA glue.

It has been observed that the methods described herein are capable of forming noble metal catalysts that exhibit improved activity over catalysts formed via identical processes absent contact with the pre-treatment agent (i.e., comparative activity). For example, the noble metal catalysts may exhibit a catalyst activity that is at least 15%, or at least 20% or at least 25% greater than the comparative activity.

It has been observed that the embodiments described herein may result in improved metal adhesion. For example, one or more embodiments result in a noble metal catalyst having a metal level such as those described previously herein. It is further contemplated that the noble metal catalyst may have a metal retention rate (i.e., a rate of retention of the initially impregnated metal) of at least 80%, or at least 85% or at least 90% or at least 95%, for example

It has further been observed that the embodiments described herein may result in shell type catalysts having a thinner metal layer than comparative catalysts absent the pre-treatment. For example, one or more embodiments may result in a shell thickness of less than 250 μm, or less than 200 μm, or less than 150 μm, or less than 100 μm, or less than 80 μm, for example. As used herein, the term “shell thickness” refers to the total thickness of metal, including the diffusive layer of metal in the catalyst and is measured by visual mapping.

The improved activities described herein may result in acetoxylation processes having improved productivity. For example, for a reactant gas molar feed composition of 50 wt. % helium/35 wt. % ethylene/4 wt. % oxygen/11 wt. % acetic acid at a feed rate of 1.2 moles per hour over 5 mL of catalyst at an internal bed temperature of 130° C. may have a converted ethylene selectivity of at least 94% while maintaining at least 20% oxygen conversion. Vinyl acetate production of this catalyst under the stated feed conditions may result in a process exhibiting a productivity or at least 250 grams VAM/liter catalyst hour.

### EXAMPLES

To facilitate a better understanding of the present invention, the following examples of preferred embodiments are given. In no way should the following examples be read to limit, or to define, the scope of the invention.

As used below, the metal levels in the analyzed catalyst (such as those shown in Table 3) were determined by analyzing the catalyst with inductively coupled plasma (ICP). There may be a 3-5% error associated with determination of the amount of Pd and Au on the catalyst. ICP is known in the art (see, Mu, X. “The Preparation of Pd/SiO₂ Catalyst by Chemical Vapor Deposition in a Fluidized-Bed Reactor” Applied Catalysis A: General 248 (2003): 85-95, which incorporated by reference herein).

As used below, the shell thickness was measured by visual mapping from extrudate cross section microscopy images.

### Example 1

A TiO₂WO₃ solid support material, TiONA® DT-52 commercially available from Millenium Inorganic Chemicals, was impregnated with a target of 0.96 wt. % Pd and 0.56 wt. % Au. The catalyst preparation procedure was as follows:

The support material was pretreated (prior to metal salt deposition) by dissolving 0.8293 grams NaHCO₃ in 9.5 grams DI water and dripping that solution over 25 grams of the support material while rotating the support material in a metal plating dish. The support was then dried overnight at 80° C.

Both the pre-treated support material and a comparative untreated support material (DT-52), were loaded with a metal component. Both the treated and untreated supports were impregnated with the same target loadings. Specifically, 25 grams of support material was impregnated by individually adding the support material to a metal salt solution. The metal salt solution was formed by mixing 8 grams DI water, 0.283 grams NaAuCl₄.2H₂O, 0.785 grams Na₂PdCl₄.3H₂O, and 0.822 grams NaHCO₃ (i.e., fixing agent) via the following process. The NaAuCl₄.2H₂O was added to the DI water, and once the pH settled around 2.1, the Na₂PdCl₄.3H₂O was added. The solution was stirred continuously until the pH stabilized at around 2.8. The NaHCO₃ was then slowly added and the CO₂ gas evolution was monitored. The pH was monitored until it stabilized at around 6.9, and the solution was stirred at room temperature for an additional 10 minutes.

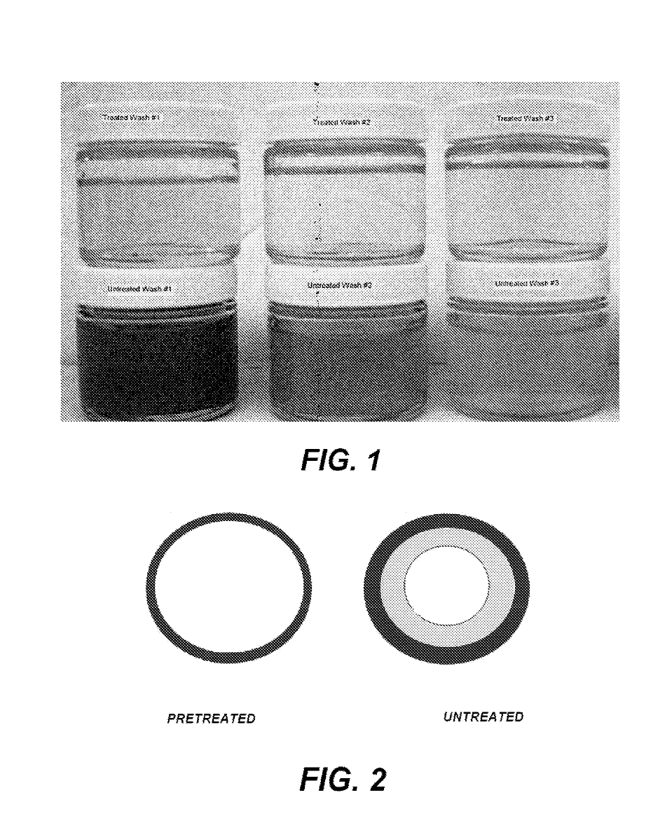

The resulting metal salt solution was then added to the support material by submerging the support material in the metal salt solution. Upon impregnation, the resulting catalyst samples were placed in an 80° C. oven for four hours and then washed with hot DI water three times. FIG. 1 shows a comparison of the resultant solution after the washing of each sample, treated and untreated. As can be seen in FIG. 1, the treated wash was lighter and therefore did not have as much metal washed out of solution. The untreated wash was darker and therefore had more metal that was not retained on the support material. Table 1 shows the Pd concentration in the wash water as shown in FIG. 1.

TABLE 1
Concentration of Pd in wash water

| | Wash #1 | Wash #2 | Wash #3 |
|---|---|---|---|
| Treated Sample | 1.76 ppm | 0.72 ppm | 0.16 ppm |
| Untreated Sample | 50.0 ppm | 11.0 ppm | 1.80 ppm |

### Example 2

A TiO₂ solid support material, TiONA® DT-51, commercially available from Millenium Inorganic Chemicals, was impregnated with 0.96 wt. % Pd and 0.56 wt. % Au.

Reagents:

1) 1 kg TiO₂ support material (calcined at 700° C.); 2) Na₂PdCl₄*3H₂O (MW=348.18 grams per mole); 3) NaAuCl₄*2H₂O (MW=397.74 grams per mole); 4) NaHCO₃; 6) DI (de-ionized) water.

Procedure:

The total pore volume of the TiO₂ support material dictated the amount of water required for 1 kg of support material. The metal impregnation solution utilizes 75-95% of the total pore volume of the catalyst support. 1 kg of TiO₂ support material at 0.96 wt. % Pd and 0.56 wt. % Au required 9.6 grams of Pd and 5.6 grams of Au or 31.41 grams Na₂PdCl₄*3H₂0 and 11.31 grams NaAuCl₄*2H₂O.

The total pore volume of the TiO₂ carrier dictated the amount of water required for 1 kg of support. The metal impregnation solution utilized 75-95% of the total pore volume of the catalyst support.

1 kg of TiO₂ carrier support at 0.96 wt % Pd and 0.56 wt % Au required 9.6 grams of Pd and 5.6 grams of Au or 31.41 grams Na₂PdCl₄*3H₂0 and 11.31 grams NaAuCl₄*2H₂O.

To a 1000 mL beaker was added 75-85% of the total pore volume of 1 Kg carrier of DI H₂O along with a magnetic stir bar. The water was stirred and 11.31 grams NaAuCl₄*2H₂O was slowly added while recording the pH. Once the pH settled around 2.1, 31.41 grams Na₂PdCl₄*3H₂O was added. The solution was stirred until the pH stabilized around 2.8, and then for an additional 10 minutes to ensure all the salt had dissolved. Next, 27 grams of NaHCO₃ was slowly added in small portions while the CO₂ gas evolution was monitored. Once all the NaHCO₃ was added, the pH was monitored until it stabilized around 6.9 and the solution was stirred at room temperature for an additional 20 minutes.

After the 20 minutes of stirring the metal salt solution, the solution was transferred in an even spray like manner to the TiO₂ carrier support. After all the metal salt solution had been added, the catalyst was heated in air at 80-120° C. for 6-24 hours to fully decompose the carbonate salts. After heating was complete, the material cooled to room temperature.

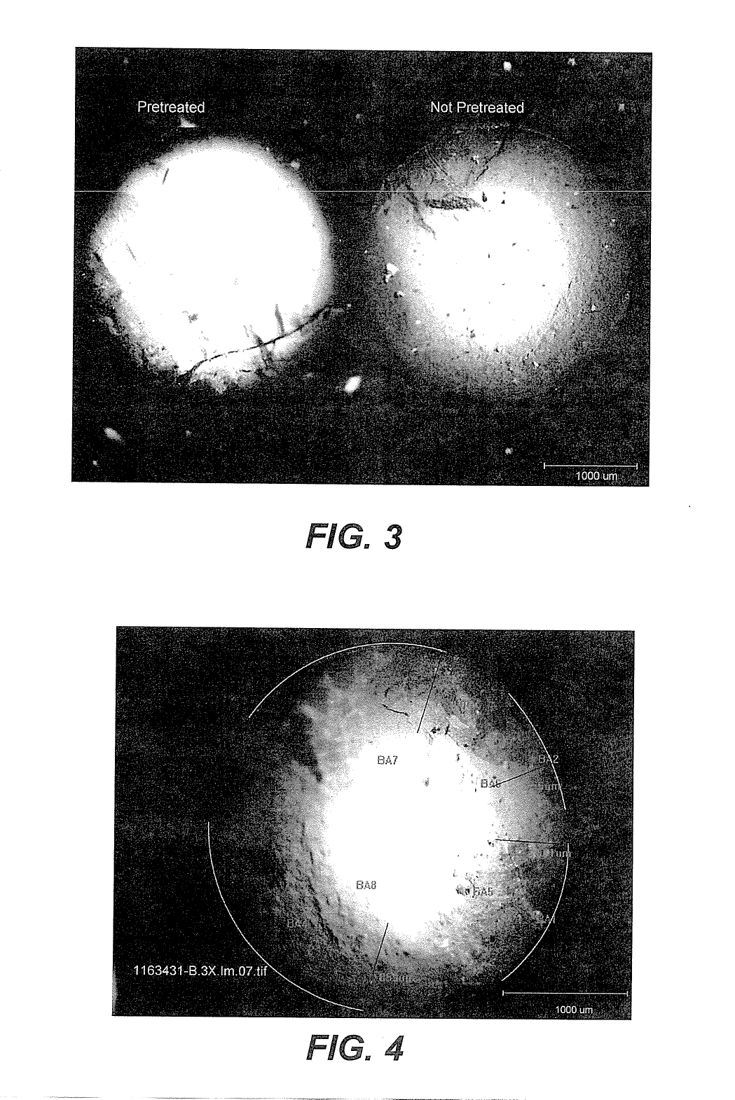

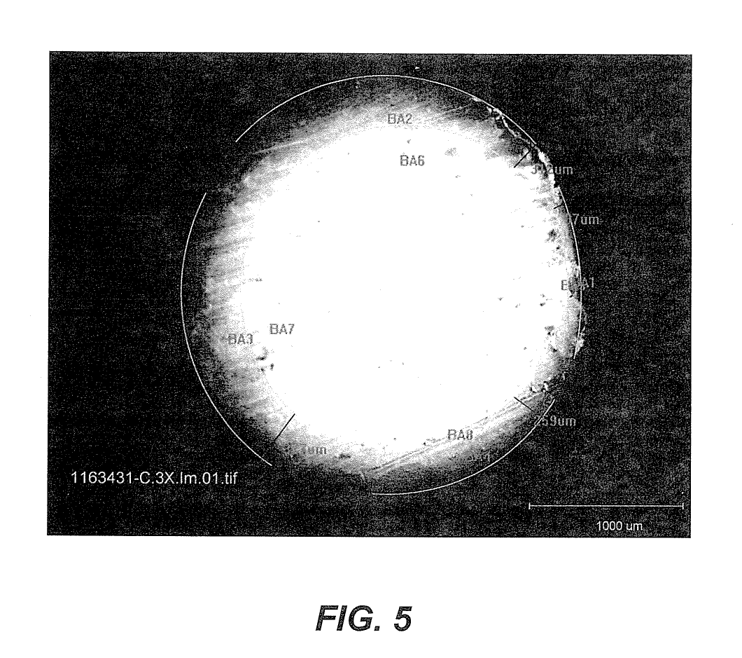

FIG. 2 illustrates the shell thickness of the Pd/Au layer for a pre-treated and untreated catalyst support material. The white center represents the pure calcined TiO₂ of the support which is substantially free of metal. The black outer circles represent the Pd/Au alloy. The light grey middle circle represents the gradient of the Pd/Au from the dense outer layer to the metal free inner layer. The typical non-pretreated catalyst has a dark black ring of about 80 μm in thickness and a grey ring of 300 μm in thickness (i.e., a shell thickness of 380 μm). The overall diameter of the extrudate was 0.125 inches. As a result of the thinner shell, it was observed that the pre-treated had a greater Pd/Au surface density (i.e., essentially the same amount of metal deposited in a smaller area). FIGS. 3, 4, and 5 are microscopy images of a pre-treated and untreated catalyst. FIG. 3 shows a cross section of the TiVAM catalyst illustrating the thickness of the active metal layer for the treated catalyst support, which was thinner than the untreated catalyst support. FIG. 4 illustrates the metal penetration depth (i.e., shell thickness) for an untreated catalyst support. FIG. 5 illustrates the metal penetration depth for a treated catalyst support.

The pre-treated and untreated catalysts were then subjected to an acetoxylation process under the following conditions: 5 ml whole particle catalyst activated with a 7 wt. % solution of potassium acetate in water was diluted with 90 grams of 2 MM Al₂O₃ and allowed to react for 40 hours under the following feed conditions listed in Table 2 below at 80 psig and 130° C.

TABLE 2
Feed conditions

| Component | Moles | Mole % |
|---|---|---|
| He | 0.587 | 47.60 |
| C₂H₄ | 0.410 | 33.27 |
| Oxygen | 0.048 | 3.92 |
| Nitrogen | 0.050 | 4.02 |
| Acetic Acid | 0.138 | 11.18 |
| Carbon Dioxide | 0.000 | 0.00 |
| Sum | 1.233 | 100.0 |

The increase in the pre-treated supported catalyst's conversion and selectivity may be attributed to the increase in the Pd/Au surface density. As can be seen in Table 3 below, the catalysts have similar levels of active metals, but there is a difference in vinyl acetate monomer (VAM) productivity. Therefore, it is believed that the improved productivity is a result if the thinner shell thickness and not because one has more active metal than the other. The data in Table 3 is based on the 34-40 hour average.

TABLE 3

| | | No NaHCO₃ |
|---|---|---|
| | NaHCO₃ pretreated | pretreatment |
| Wt % Pd | 0.88 | 0.92 |
| Wt % Au | 0.46 | 0.52 |
| Pd/Au shell | 377 μm (at the thickest) | 859 μm (at the thickest) |
| thickness | | |
| Oxygen conversion | 24.5% | 20.5% |
| Oxygen selectivity | 76.1% | 75.0% |
| Ethylene selectivity | 94.9% | 94.6% |
| VAM productivity | 301 g VAM/L cat- h | 248 g VAM/L cat- h |

### CLOSING OF THE DETAILED DESCRIPTION

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention.

The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values.

The following patents and/or patent applications are hereby incorporated by reference for the purposes described above as if set forth verbatim herein:
International Patent Application WO 2011/075278, entitled “Preparation of Palladium-Gold Catalyst”, and filed Nov. 19, 2010, in the name of the inventor(s) Daniel Travis Shays and Yuanzhang Han, and assigned on its face to Lyondell Chemical Technology, L.P.
U.S. Letters Pat. No. 6,022,823, entitled “Process for the Production of Supported Palladium-Gold Catalysts”, and issued Feb. 8, 2000, in the name of the inventor(s) Steven M. Augustine, et al. and assigned on its face to Millennium Petrochemicals, Inc.;
U.S. Letters Pat. No. 3,743,607, entitled “Palladium-Gold Catalyst”, and issued Jul. 3, 1973, in the name of the inventor(s) Hurt Sennewald et al. and assigned on its face to Knapsack Akteingesellschaft; and
U.S. Letters Pat. No. 3,775,342, entitled “Process for the Production of Catalysts for Making Vinyl Esters”, and issued Nov. 27, 1973, in the name of the inventor(s) and assigned on its face to Bayer Aktiengesellschaft.

If there is any conflict in the usages of a word or term in this specification and one or more patent or other documents that may be incorporated herein by reference, the definitions that are consistent with this specification should be adopted.

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method of forming a noble metal catalyst comprising:
contacting a support material with a pre-treatment agent comprising a dilute basic solution of an alkali or alkaline earth metal to form a contacted support;
drying the contacted support to form a pre-treated support; and
impregnating the pre-treated support with at least one noble metal to form the noble metal catalyst exhibiting a catalyst activity greater than a comparative activity of a catalyst formed from a same process absent the contact with the pre-treatment agent.

2. The method of claim 1, wherein the support material is selected from titania, tungsten trioxide and combinations thereof.

3. The method of claim 1, wherein the dilute basic solution is selected from hydroxides, carbonates and combinations thereof.

4. The method of claim 1, wherein the dilute basic solution is saturated.

5. The method of claim 1, wherein the pre-treatment agent comprises NaHCO₃.

6. The method of claim 1, wherein the pre-treatment agent contacts the catalyst support in an amount of from 0.1 times the volume of the support material to a volume sufficient to saturate the support material.

7. The method of claim 1, wherein the pre-treatment agent contacts the catalyst support for a time of at least 10 minutes.

8. The method of claim 1, wherein the noble metal is selected from palladium, gold and combinations thereof.

9. The method of claim 1, wherein the noble metal comprises palladium and gold.

10. The method of claim 9, wherein the catalyst comprises from 0.75 wt. % to 1 wt. % palladium and from 0.35 wt. % to 0.6 wt % gold based on the total weight of the catalyst.

11. The method of claim 1, wherein the noble metal catalyst activity is at least 15% greater than the comparative activity.

12. The method of claim 1, wherein the support material is calcined prior to contact with the pre-treatment agent.

13. The method of claim 1, wherein the support material is calcined at a calcining temperature of from 450° C. to 1100° C. prior to contact with the pre-treatment agent.

14. The method of claim 1 further comprising contacting the at least one noble metal with a fixing agent prior to impregnating the support material with the at least one noble metal.

15. The method of claim 14, wherein the fixing agent is selected from alkali or alkaline earth metals, ammonium compounds and combinations thereof.

16. A noble metal catalyst formed by the method of claim 1.

17. The method of claim 1, wherein the support material consists essentially of titania.

18. The method of claim 17, wherein the support material is submerged in the pre-treatment agent to form the contacted support.

19. A noble metal catalyst formed by the method of claim 17, wherein the noble metal catalyst comprises a shell thickness of less than 250 μm.

20. The method of claim 1, wherein the support material comprises titania and tungsten trioxide.

21. An noble metal catalyst formed by the method of claim 21, wherein the noble metal catalyst comprises a metal retention rate of at least 90%.

22. An acetoxylation process comprising:
contacting an olefin with acetic acid in the presence of the noble metal catalyst of claim 16 to form an acetoxylated olefin; and
recovering the acetoxylated olefin.

23. The process of claim 22, wherein the olefin comprises ethylene and the acetoxylated olefin comprises vinyl acetate.

24. The process of claim 22, wherein the process exhibits a productivity of at least 250 g acetoxylated olefin/Lcat-h and an ethylene selectivity of at least 94% while maintaining at least 20% oxygen conversion.

25. An acetoxylation process comprising:
contacting an olefin with acetic acid in the presence of an acetyloxylation catalyst to form an acetoxylated olefin comprising vinyl acetate; and
recovering the acetoxylated olefin;
wherein the noble metal catalyst is formed by a process comprising:
providing a support material comprising a refractory metal oxide selected from titania, tungsten trioxide and combinations thereof;
calcining the support material to form a calcined support;
contacting the calcined support with a pre-treatment agent comprising a dilute basic solution of an alkali or alkaline earth metal to form a contacted support;
drying the contacted support to form a pre-treated support;
impregnating the pre-treated support with noble metals comprising gold and palladium to form a catalyst, wherein the noble metals are impregnated in the presence of a fixing agent selected from alkali or alkaline earth metal, ammonium compounds and combinations thereof; and
washing the catalyst to form the noble metal catalyst, wherein the noble metal catalyst exhibits a catalyst activity that is greater than a comparative activity of a catalyst formed from an identical process absent the contact with the pre-treatment agent.
